(19) United States
(12) Patent Application Publication
(10) Pub. No.: US 2022/0026226 A1
(43) Pub. Date: Jan. 27, 2022

(54) Visual Boundary Segmentations And Obstacle Mapping For Agricultural Vehicles

(71) Applicant: Ag Leader Technology, Ames, IA (US)

(72) Inventor: Scott Eichhorn, Ames, IA (US)

(21) Appl. No.: 17/381,900

(22) Filed: Jul. 21, 2021

Related U.S. Application Data
(60) Provisional application No. 63/054,411, filed on Jul. 21, 2020.

(51) Int. Cl. G01C 21/34; B60Q 9/00; G01S 19/49; G06K 9/00; G06K 9/62

(52) U.S. Cl. CPC G01C 21/3461; B60Q 9/008; B60K 35/00; G06K 9/0063; G06K 9/6267; G01S 19/49

(57) ABSTRACT

A collision avoidance system including an agricultural vehicle, at least one sensor disposed on the vehicle, a GPS disposed on the vehicle, where the GPS in communication with the sensor, and a storage medium. The sensor is constructed and arranged to detect obstacles and in conjunction with the GPS locate and map the objects for storage of the obstacle's location in the storage medium.

### CROSS REFERENCE TO RELATED APPLICATION(S)

This application claims the benefit under 35 U.S.C. § 119(e) to U.S. Provisional Application 63/054,411, filed Jul. 21, 2020, and entitled “Visual Boundary Segmentations and Obstacle Mapping for Agricultural Vehicles,” which is hereby incorporated herein by reference in its entirety for all purposes.

### TECHNICAL FIELD

The disclosure relates to collision avoidance and steering of various vehicles particularly agricultural vehicles and implements.

### BACKGROUND

The collision of agricultural vehicles and implements with various obstacles can cause economic loss due to repair costs and lost productivity. Many agricultural vehicles are large, having great widths and lengths, making them more susceptible to collisions. For example, planters and sprayers currently in use can be up to 120 feet in width, while various harvest combine augers are upwards of 40 feet in length. The trend of increasing equipment size in turn also increases the likelihood and severity of collisions.

There is a need in the art for various devices, systems, and methods for preventing collisions.

### BRIEF SUMMARY

Disclosed herein are various devices, systems, and methods for use in agricultural collision avoidance, navigation, and mapping.

In Example 1 a collision avoidance system comprising: at least one sensor disposed on a vehicle; a GPS disposed on the vehicle, the GPS in communication with the sensor; and a storage medium in communication with the GPS and the sensor, wherein the at least one sensor is constructed and arranged to detect and locate objects.

Example 2 relates to the collision avoidance system of Example 1, wherein the storage medium is a map or a database.

Example 3 relates to the collision avoidance system of Example 1, further comprising an inertial measurement unit in communication with the GPS.

Example 4 relates to the collision avoidance system of Example 1, further comprising an operations system configured to generate guidance paths for avoiding collisions with detected objects.

Example 5 relates to the collision avoidance system of Example 1, wherein the operations system is configured to determine an uncertainty of an object location and a collision probability, and wherein the operations system is configured to emit an alarm when the collision probability exceeds a threshold probability.

Example 6 relates to the collision avoidance system of Example 1, wherein the GPS is at a known offset from the at least one sensor, and wherein the collision avoidance system utilizes a GPS position, the known offset, and data of detected objects to localize and map objects.

Example 7 relates to the collision avoidance system of Example 1, wherein detected objects are classified as permanent or non-permanent.

In Example 8 a navigation system comprising: one or more collision avoidance sensors disposed on a first vehicle configured to detect objects and object data; and an operations system in communication with the one or more collision avoidance sensors. The operations system comprising: a central processing unit configured to receive object data from the one or more collision avoidance sensors; a storage medium in communication with the central processing unit for storage of the object data; and a communications link in communication with the storage medium, the communications link configured for transmitting object data to one or more second vehicles, wherein the navigation system is configured to generate guidance for the one or more second vehicles to avoid collisions with objects.

Example 9 relates to the navigation system of Example 8, wherein the storage medium comprises one or more of a map and a database.

Example 10 relates to the navigation system of Example 8, wherein the object data includes one or more of an object image, object GNSS coordinates, object size, object distance from the one or more collision avoidance sensors, and object identification/classification.

Example 11 relates to the navigation system of Example 8, further comprising a graphical user interface (GUI) in communication with the operations system configured to display object data to a user.

Example 12 relates to the navigation system of Example 8, wherein the operations system is configured to classify objects as permanent or non-permanent.

Example 13 relates to the navigation system of Example 8, further comprising a convolutional neural network for object classification.

Example 14 relates to the navigation system of Example 8, wherein the central processing unit is further configured to receive aerial imagery for integration with the object data.

In Example 15 a system for navigation and collision avoidance comprising: a processor in communication with at least one collision avoidance sensor on a first vehicle; a memory in communication with the processor configured to store data from the at least one collision avoidance sensor; and a navigation system in communication with the memory and a second vehicle configured to generate path guidance for avoidance of collisions with objects detected by the at least one collision avoidance sensor.

Example 16 relates to the system of Example 15, wherein the system is configured for locating objects globally via data provided by the at least one collision avoidance sensor; recognizing objects; classifying objects; and creating and updating maps of objects.

Example 17 relates to the system of Example 16, wherein the system is further configured for integrating object locations with aerial imagery.

Example 18 relates to the system of Example 16, wherein objects are classified as permanent or non-permanent, and wherein non-permanent objects are not included in maps of objects.

Example 19 relates to the system of Example 16, wherein maps of objects are dynamically updated.

Example 20 relates to the system of Example 15, wherein the second vehicle does not have collision avoidance sensors.

While multiple embodiments are disclosed, still other embodiments of the disclosure will become apparent to those skilled in the art from the following detailed description, which shows and describes illustrative embodiments of the invention. As will be realized, the disclosure is capable of modifications in various obvious aspects, all without departing from the spirit and scope of the disclosure. Accordingly, the drawings and detailed description are to be regarded as illustrative in nature and not restrictive.

### BRIEF DESCRIPTION OF THE DRAWINGS

FIG. 1 is an exemplary depiction of an agricultural environment.

FIG. 2 is an exemplary aerial depiction of an agricultural environment.

FIG. 3 is a schematic depiction of the system, according to one implementation.

FIG. 4 is a schematic depiction of the system, according to one implementation.

FIG. 5 is an exemplary depiction of a map, according to one implementation.

FIG. 6 shows a map, according to one implementation.

FIG. 7 shows an exemplary display, according to one implementation.

FIG. 8 is a flow diagram for mapping by the system, according to one implementation.

FIG. 9 shows detection of an object by a vehicle, according to one implementation.

FIG. 10 shows a guidance path for a vehicle to avoid the object detected in FIG. 9, according to one implementation.

FIG. 11 shows a vehicle following the guidance path of FIG. 10 to avoid a collision with the object, according to one implementation.

FIG. 12 shows detection of an object by a vehicle and transmission of object information to a second vehicle, according to one implementation.

FIG. 13 shows detection of an object by a vehicle and transmission of object information to a second vehicle via a cloud system, according to one implementation.

FIG. 14 shows a guidance path for the second vehicle of either FIG. 12 or 13 for navigation alongside the detected object, according to one implementation.

FIG. 15 shows the second vehicle of FIG. 14 alongside the detected object after following the guidance path, according to one implementation.

### DETAILED DESCRIPTION

Described herein is a system for creating and maintaining one or more up-to-date maps and/or databases for collision avoidance and navigation. In various implementations, the system is constructed and arranged to avoid collisions between agricultural vehicles, implements, and various obstacles or objects. As would be understood, such collisions can cause lost productivity and repair expenses but typically are not frequent/severe enough to justify outfitting all equipment with collision sensors for on-board collision avoidance.

In various implementations, the disclosed system generates maps and/or databases of objects using various collision avoidance sensor(s) and/or guidance sensor(s) on one or more vehicles, and optionally other inputs as will be discussed further below. These maps and/or databases may then be used to assist in navigation and collision avoidance for any vehicle equipped with a global navigation satellite system (“GNSS”) regardless of if the particular vehicle is outfitted with collision avoidance sensors. That is, the system, in some implementations, provides for the ability to share object locations via maps, databases, and/or other data sharing mechanisms, such that a vehicle need not have collision sensors and can still benefit from alerts and/or guidance to avoid costly collisions.

Various implementations of the system can be used in conjunction with any of the devices, systems, or methods taught or otherwise disclosed in: U.S. Pat. No. 10,684,305, issued Mar. 8, 2019, and entitled “Apparatus, Systems, and Methods for Cross Track Error Calculation From Active Sensors”; U.S. patent application Ser. No. 16/918,300, filed Jul. 1, 2020, and entitled “Apparatus, Systems, and Methods for Eliminating Cross-Track Error”; U.S. patent application Ser. No. 16/921,828, filed Jul. 6, 2020, and entitled “Apparatus, Systems and Methods for Automatic Steering Guidance and Visualization of Guidance Paths”; U.S. patent application Ser. No. 16/939,785, filed Jul. 27, 2020, and entitled “Apparatus, Systems, and Methods for Automated Navigation of Agricultural Equipment”; U.S. patent application Ser. No. 16/997,361, filed Aug. 19, 2020, and entitled “Apparatus, Systems and Methods for Steerable Toolbars”; U.S. patent application Ser. No. 17/132,152, filed Dec. 23, 2020, and entitled “Use of Aerial Imagery For Vehicle Path Guidance and Associated Devices, Systems, and Methods”; U.S. patent application Ser. No. 17/323,649, filed May 18, 2021, and entitled “Assisted Steering Apparatus and Associated Systems and Methods”; U.S. patent application Ser. No. 17/193,510, filed Jul. 7, 2021, and entitled “Apparatus, Systems And Methods For Grain Cart-Grain Truck Alignment And Control Using Gnss And/Or Distance Sensors”; and U.S. Provisional Patent Application 63/186,995, filed May 11, 2021, and entitled “Calibration Adjustment for Automatic Steering Systems.”

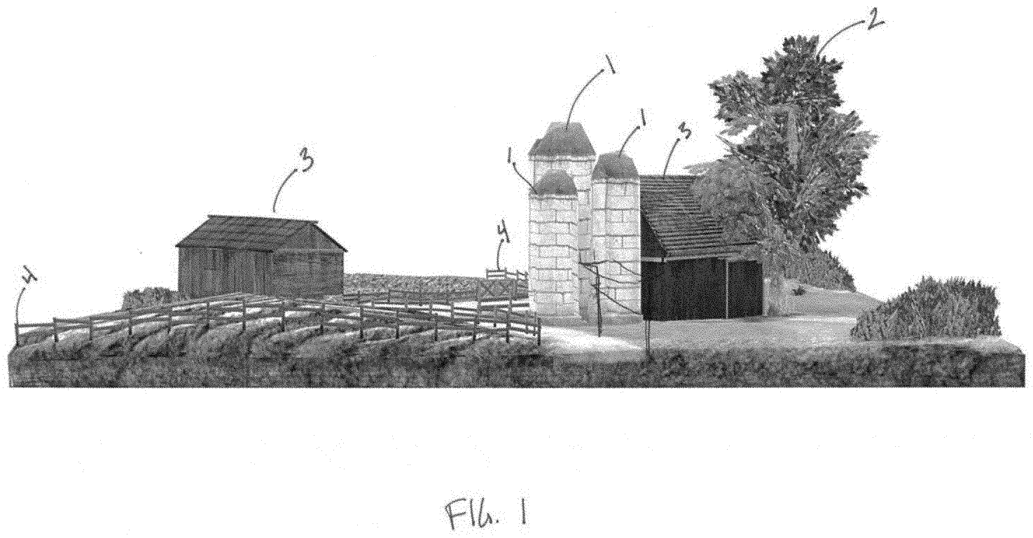

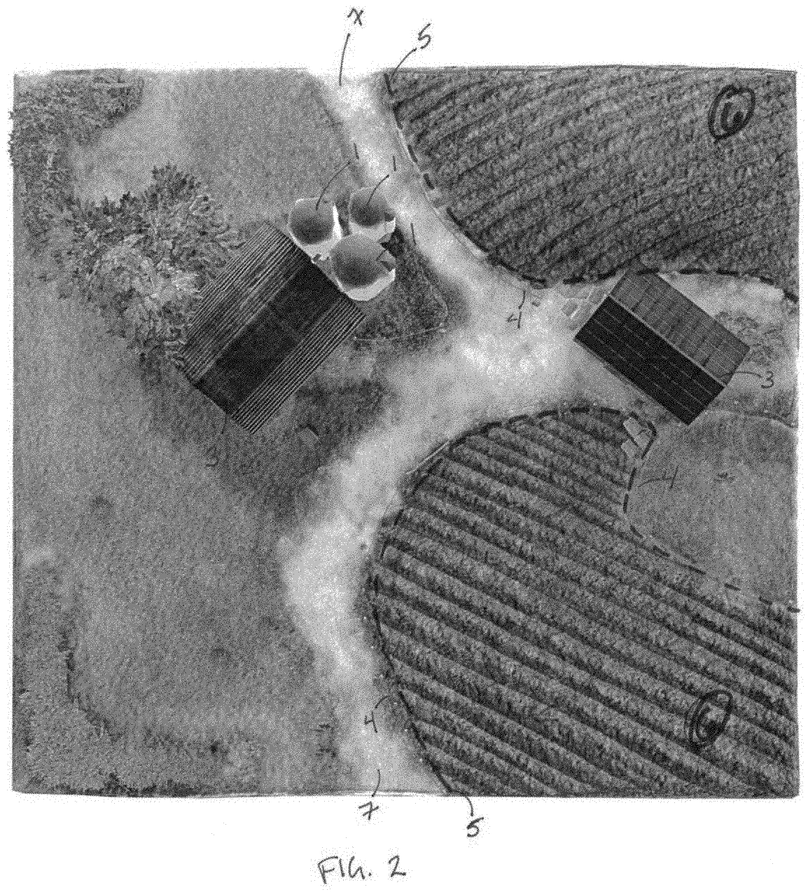

Turning to the figures in more detail, it is readily appreciated that agricultural environments may have a number of objects 10 that carry a risk of collision, including but not limited to grain silos 1, trees 2, buildings 3, telephone poles, fences 4, drain tile surface inlets, and other objects 10 as would be appreciated, some of which are shown in FIG. 1. Additionally, agricultural environments may also have various other objects 10 including natural and manmade features including without limitation fields 6, field boundaries 5, waterways, terraces, groves, and roads 7 among others, certain of which are shown in FIG. 2. The location(s) and various properties of objects 10 may be of interest to operators and/or stakeholders for guidance and optional inclusion in maps and databases for collision avoidance and navigation.

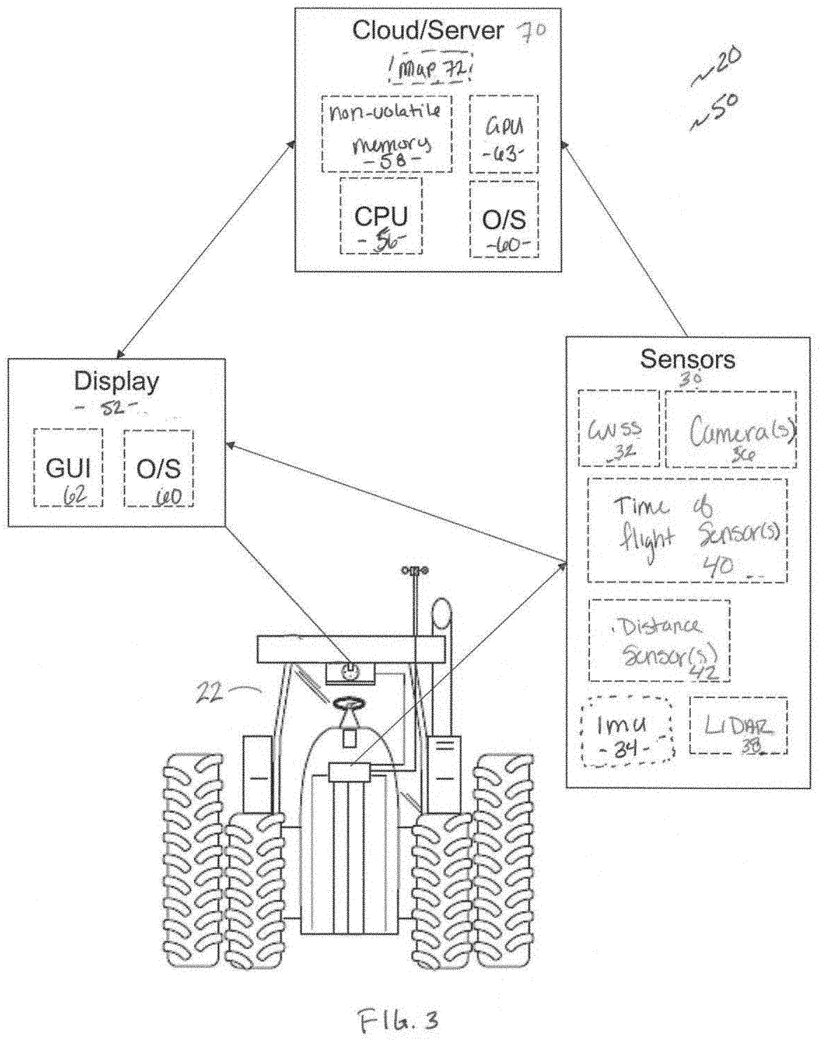

In various implementations of the system 20, as shown in FIG. 3, an agricultural vehicle 22 is outfitted with one or more object detection sensors 30 to detect objects 10 that may provide a collision or navigation hazard. In various implementations, the object detection sensors 30 may include, but are not limited to single cameras 36 such as Mobileye Supervision, stereo cameras 36 such as the Stereo Labs Zed 2i, cameras 36 utilizing structured light patterns such as the Intel RealSense 435, LIDAR 38 such as the Velodyne Puck, time of flight sensors 40 such as the IFM O3M, 1D, 2D and/or 3D distance sensors 42 such as but not limited to NXP TEF810x radar, or the like as would be appreciated. It would be understood that the various sensor 30 examples provided herein are merely exemplary and other sensors 30 are possible. Any appropriate object detection sensor 30 may be used, such as sensors 30 used in advanced driver assistance systems and/or in simultaneous localization and mapping systems for robot navigation, as would be appreciated by those of skill in the art. Certain non-limiting examples include NavVis VLX, Emesent Hovermap, and SlamTec Apollo. Various algorithms and methods for simultaneous localization and mapping are known and recognized in the art and are discussed in Taketomi, T., Uchiyama, H. & Ikeda, S. Visual SLAM algorithms: a survey from 2010 to 2016. IPSJ T Comput Vis Appl 9, 16 (2017), which is incorporated herein by reference.

In certain implementations, the system 20 may use sensor fusion, that is combining the data from multiple sensors, to improve the accuracy of object 10 detection and localization. In one exemplary implementation, the system 20 includes an RGB camera and be configured to use image recognition algorithms to detect an object 10, as would be understood. In these and other implementations, the RBG camera or other single sensor 30 may be not able to determine the location of the object 10—the distance and direction of the object 10 to the sensor 30. In these implementations, the system 20 may implement sensor fusion to include a laser rangefinder or other second sensor 30 to determine the distance and direction/orientation of the object 10 to the sensor 30. In one example of sensor fusion, combining range information with the image, such as from the RBG camera, may also allow for the size of the object 10 to be determined and thereby allow for a more accurate object 10 classification, as will be discussed further below. Sensor fusion may be used in implementations of the system 20 having any number of the sensors 30 discussed or contemplated herein.

In various implementations, the system's 20 object detection sensors 30 are used in conjunction with a vehicle 22 equipped with a Global Navigation Satellite System (“GNSS”) 32 to precisely locate and map obstacles 10 that may be collision or navigation hazards. That is, in certain implementations, a GNSS 32 is provided that is configured or otherwise interfaced with one or more sensors 30 to calculate and store object 10 locations in maps 72 or other databases 58 for future use and/or use by other vehicles. It would be understood that GNSS is the standard generic term for satellite navigation systems that provide autonomous geo-spatial positioning with global coverage. Certain non-limiting examples include GPS, GLONASS, Galileo, Beidou, and other GNSS. It is understood that, for example, the terms GNSS and GPS (global positioning system) are used interchangeably herein.

In further implementations, the system 20 may also include an inertial measurement unit (“IMU”) 34, such as VectorNav VN-100, Lord 3DM-CX5-10 IMU, and Bosch BMI090L, for use in conjunction with a GPS 32 to improve the positional accuracy of the vehicle 22 and object detection measurements, as would be appreciated.

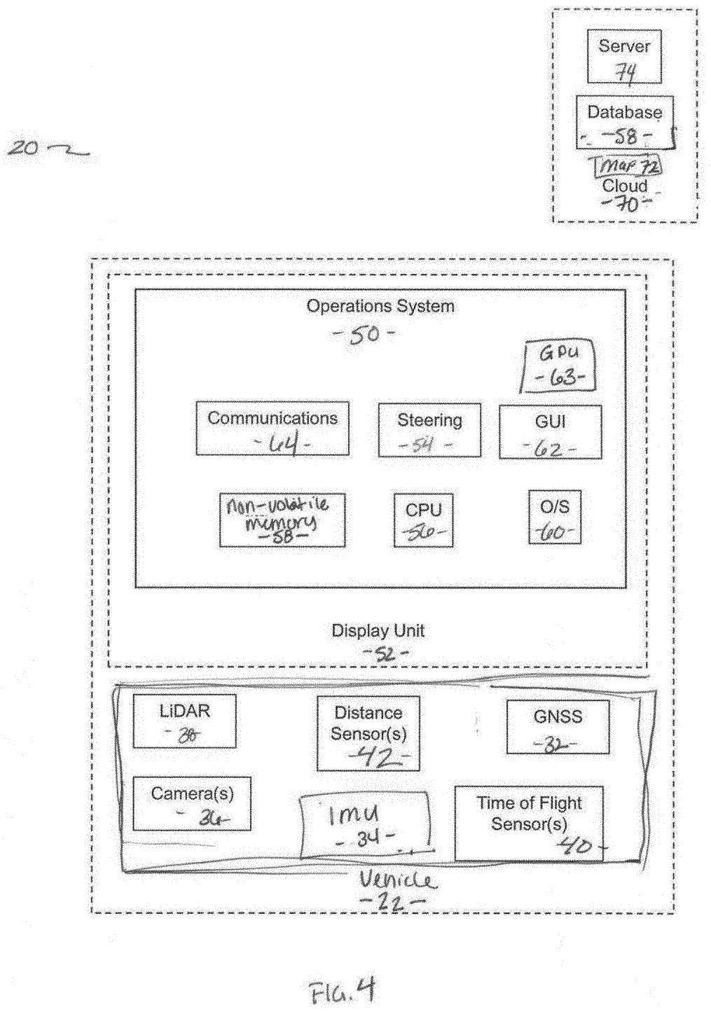

Continuing with the implementations of FIGS. 3 and 4, the sensors 30 are in operational communication via a wired or wireless connection with an operations system 50. In some implementations, the system 20 provides an operations system 50 optionally comprised in a display 52, such as the InCommand® display from Ag Leader®. In alternative implementations, the operations system 50 may optionally be disposed on a cloud-based system 70, and/or comprise both local/display 52 components as well as cloud 70 based components, as would be understood.

In various implementations, the operations system 50 includes a steering system 54 for automatic and/or assisted steering of vehicles 22 along guidance paths generated to avoid collisions with objects 10 and navigation around various hazards, as would be appreciated and described in certain of the incorporated references. Further, in some implementations, the steering system 54 provides one or more commands to a vehicle 22 to use automatic speed and/or throttle control to stop or slow the vehicle 22 in order to prevent a collision, as would be understood.

In various implementations of the system 20, the operations system 50 further includes the various processing and computing components necessary for the operation of the system 20, including receiving, recording and processing the various received signals, generating the requisite calculations and commanding the various hardware, software and firmware components necessary to effectuate the various processes described herein. That is, in certain implementations, the operations system 50 comprises a processor 56 or CPU 56 that is in communication with a non-volatile memory 58 or other data storage component 58 and an operating system 60 or software and sufficient media to effectuate the described processes, and can be used with an operating system 60, a non-volatile memory 58/data storage 58 and the like, as would be readily appreciated by those of skill in the art. It is appreciated that in certain implementations, the data storage 58 can be local, as shown in FIG. 4, or cloud-based as shown in FIG. 3, or some combination thereof.

In various implementations, the system 20 and operations system 50 can comprise a circuit board, a microprocessor, a computer, or any other known type of processor or central processing unit (CPU) 56 that can be configured to assist with the operation of the system 20. In further embodiments, a plurality of CPUs 56 can be provided and operationally integrated with one another and the various components of other systems on the vehicle 22 or used in connection with the vehicle 22 or agricultural operations, as would be appreciated. Further, it is understood that operations system 50 and/or its processors 56 can be configured via programming or software to control and coordinate the recordings from and/or operation of various sensor components, such as the sensors 30, as would be readily appreciated.

Continuing with FIGS. 3 and 4, in further implementations, the display 52 and/or remote cloud system 70 include a graphical user interface (“GUI”) 62 and a graphics processing unit (“GPU”) 63. In these and other implementations, the GUI 62 and/or GPU 63 allows for the display of information to a user and optionally for a user to interact with the displayed information, as would be readily appreciated. It would be understood that various input methods are possible for user interaction including but not limited to a touch screen, various buttons, a keyboard, or the like.

Further implementations of the operations system 50 includes a communications component 64. The communications component 64 is configured for sending and/or receiving communications to and from one or more of the vehicles 22, the object detection sensors 30, the cloud system 70, or any other system 20 components, as would be appreciated.

In certain implementations, the sensors 30 are constructed and arranged to detect objects 10 and measure the distance and direction of the object 10 from the vehicle 22 and/or the sensor(s) 30. In some implementations, the system 20 is constructed and arranged to work in conjunction with the GPS 32 to calculate and store the location of the object 10, as would be appreciated. That is, the system 20 is constructed and arranged to survey the location of an object 10 by offsetting the reported location of the vehicle 22 by the distance and direction of the object 10 detected by one or more sensors 30.

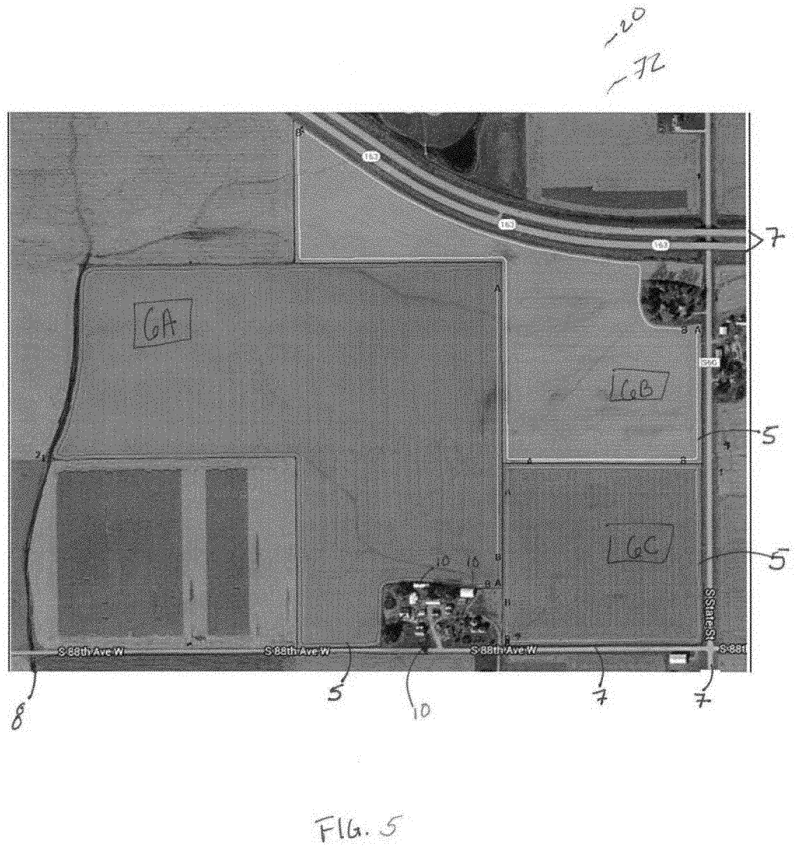

Turning now to FIG. 5, as would be appreciated, having field 6A, 6B, 6C boundaries 5 and other natural boundaries/features mapped, such as those formed by waterways 8 or roads 7, is useful for navigational purposes but can be tedious and time consuming to input and maintain. So, in various implementations, the sensors 30, including a GPS 32, are configured to detect and place field 6A, 6B, 6C boundaries 5 on a map 72 for use in storage and plotting of the objects 10. In various alternative implementations, field 6A, 6B, 6C boundaries 5 may be inputted by a user or otherwise obtained by the system 20, such as from a cloud 70 database 58 or server 74. The system 20 thereby eliminates the hassle and expense of mounting, calibrating, and maintaining collision/object detection sensors 30 on every vehicle 22 in use while still providing the advantages or assisted/automatic navigation and collision avoidance. The system 20 described herein may be used in conjunction with the various teachings and implementations of assisted/automated steering and guidance systems such as those in U.S. patent application Ser. No. 16/921,828 filed Jul. 6, 2020, which is incorporated by reference herein.

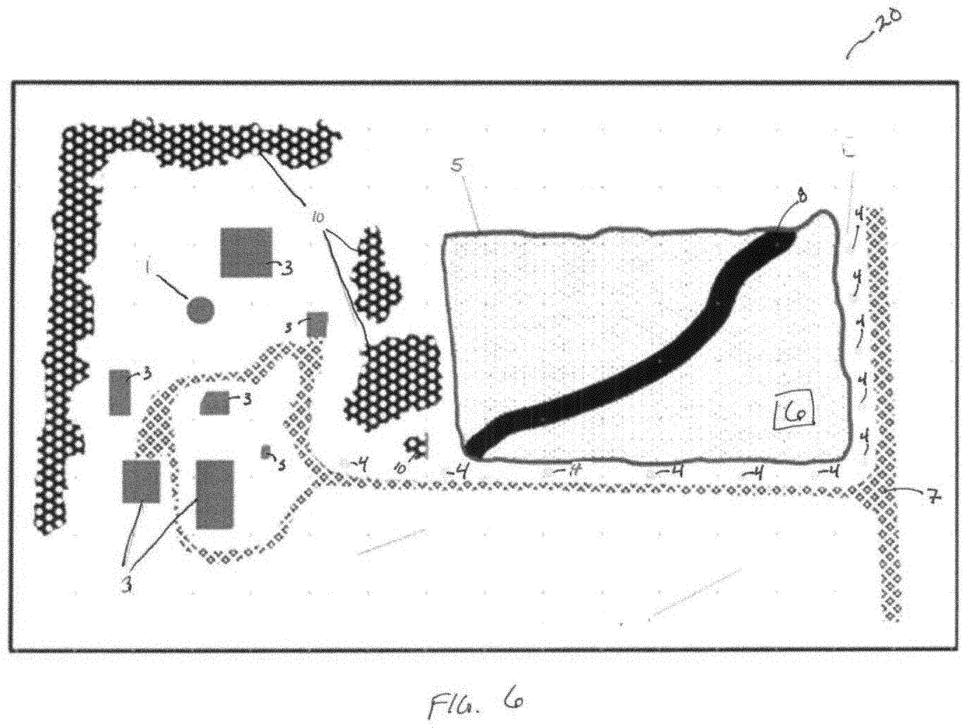

Continuing with FIGS. 5 and 6, in various implementations, the system 20 assigns GPS or other coordinates to the field map 72 including coordinates for field 6, 6A, 6B, 6C boundaries 5 and detected obstacles 10. In these and other implementations, the coordinates/locations are stored in a digital map 72, such as that shown in FIG. 6, a database 58, or other storage medium for later access and/or sharing, as would be appreciated. In various implementations, the map 72 and/or database 58 is stored in the cloud 70, as discussed above.

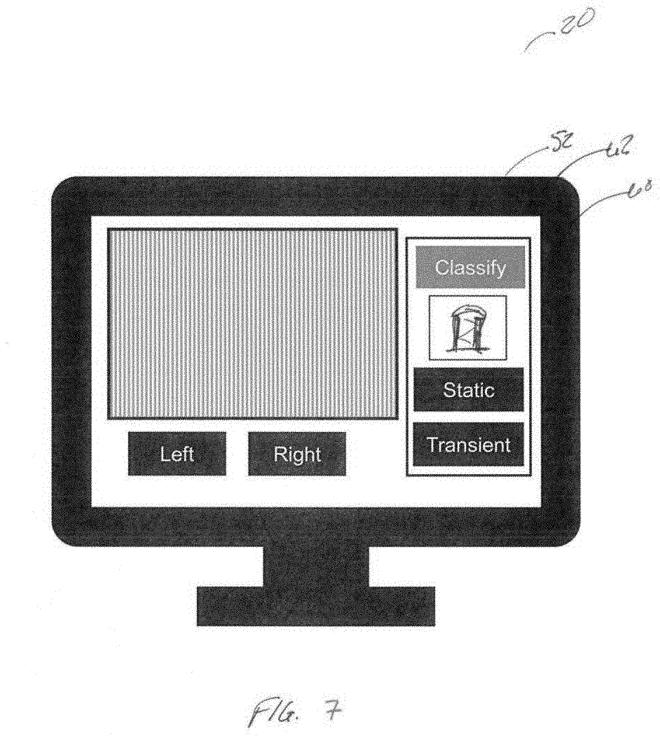

In some implementations, the system 20 is able to classify the detected objects 10 to exclude certain non-permanent objects 10. For example, mobile objects such as but not limited to vehicles, animals, hay bales, people, and other portable objects 10 may be excluded from the maps 72, because due to their transitory nature where they are unlikely to be in the same position for an extended duration. Further, in some implementations, the non-permanent objects 10 may be retained on the map 72 for a limited period of time, such as 2 hours, 8 hours, 1 week, etc., before being removed. In certain implementations, the length of time the non-permanent object 10 is retained on the map 72 varies depending on the type of object 10, for example hay bales may be expected to be in the same place for a longer period of time than an animal or person and as such would be retained on the map 72 for a longer period. In some implementations, an operator may classify objects 10 as permanent, semi-permanent, or temporary, such as by using an interface with the GUI 62 on a display 52 shown for example in FIG. 7. In some implementations, the operator may classify objects 10 in real-time, near real-time, or at any time after detection. For example, in certain implementations, the operator may classify objects 10 based on sight via the GUI 62, as would be appreciated.

In various implementations, certain objects 10 may include unique identifiers for detection by the various sensors 30 to assist in object 10 classification. For example, a vehicle may include one or more reflectors, such as those described in U.S. application Ser. No. 17/369,876 which is incorporated by reference herein, to identify a specific object 10, such as a vehicle or building. The various reflectors or other unique identifiers can be applied in a pattern, color, or shape that is uniquely identifiable from other unique identifiers on other objects 10. Unique identifiers may include RFID tags, QR codes, patterned stickers or other patches, or the like as would be appreciated. In further implementations, the unique identifier may be inherent to the object 10 such as a known pattern of lights, symbols, and/or other characteristics on a building or vehicle.

In certain implementations, the classification process is automated and may implement various machine learning techniques, as would be readily appreciated. In various of these implementations, the system 20 may analyze sensor 30 feedback—such as but not limited to images, video, and point clouds—using convolutional neural networks (“CNNs”) for object classification. As would be recognized, CNNs may be used as part of image recognition software and systems. Various other automation techniques are of course possible.

In various implementations, the CNN or other artificial intelligence system is configured to classify objects 10 and include a confidence level that the object 10 is what it has been classified as. In certain of these implementations, the system 20 may be configured to prompt a user to confirm or reject the classification of an object 10 if the confidence level is at or below a certain threshold. For example, if the system 20 detects what it thinks, based on the CNN or other artificial intelligence system, is a grain silo 1, but the confidence level is low (for example less than 50%), the system 20 may then display the image/object data to a user for feedback/input as to the classification. The user responses may then be used to correctly classify the object 10, and also to train the CNN or other artificial intelligence system and improve recognition accuracy, as would be appreciated. Further examples of machine learning and CNN algorithms are discussed in LeCun Y., Haffner P., Bottou L., Bengio Y. (1999) Object

Recognition with Gradient-Based Learning. In: Shape, Contour and Grouping in Computer Vision. Lecture Notes in Computer Science, vol 1681. Springer, Berlin, Heidelberg; Convolutional Neural Networks: Architectures, Convolution/Pooling Layers, CS231 Convolutional Neural Networks for Visual Recognition, Class Notes Stanford University (Spring 2021); and ML Practicum: Image Classification, Convolutional Neural Networks, Machine Learning Practica, Google, each of which is incorporated by reference herein.

As discussed herein, in various implementations, the stored maps 72 and/or object 10 locations can be used by vehicles 22 for navigation and collision avoidance. For example, the system 20 may be integrated with SteerCommand® Z2 from Ag Leader, or other similar agricultural navigation systems. In certain enterprise implementations, the stored maps 72, databases 58, and/or other storage 58 containing object 10 locations, sizes, and other parameters can be used by other vehicles 22, such as vehicles and/or implements that do not have collision or object detection sensors 30, and that may be operating in the same area either at the same time as or after the detecting vehicle 22.

As previously noted, the maps 72, databases 58, and/or other media containing object 10 locations and other object 10 information may be used for path planning, collision warnings, and/or automatic swath control operations. As would be recognized by those of skill in the art, automatic swath control operations include the ability to turn on/off certain sections or rows of an implement, such as a planter or fertilizer/herbicide applicators. This functionality can be useful in preventing dual application of products or seed to the same area thereby saving famers and other stakeholder money and reducing waste. This is because the size and shapes of many fields are irregular, and as such it is unlikely that an implement will be able to perfectly treat/plant an entire field with no overlap, as is understood. Using GPS mapping, the equipment in the field now knows where it has been during each pass and can control operations to limit double application/treatment. Automatic swath control operations have further advantages as would be appreciated by those of skill in the art.

In some implementations, the maps 72 may be combined with other/prior maps 72 containing previously identified obstacles 10, boundaries 5, and/or other hazards, some of which the vehicle 22 and/or collision sensors 30 may be unable to detect. For example, the maps 72 and/or a database 58 may be combined with one or more of aerial images, field survey information, user inputted data, drainage tile maps, satellite images, reported locations of other nearby vehicles equipped with positioning equipment, or other terrain/object 10 data.

As would be appreciated, many agricultural vehicles 10 and implements are capable of extending and retracting structures to allow for field 6 operation and road 7 transport. The status of these structures may be monitored by the system 20, via any known or appreciated mechanism, in some implementations, to provide accurate collision warnings and prevent nuisance false alarms. For example, a combine with its unloading auger extended may be at risk of a collision with a nearby grain silo 1, but not if the auger is retracted. In this example, by monitoring the state of the auger an alarm would only sound when the auger was extended. These implementations may also be used similarly for planters, sprayers, and tillage implements among others, as would be recognized by those of skill in the art in light of this disclosure.

Further in some implementations, the maps 72 are updated on-the-go, periodically, year over year, or at any desired interval. For example, as field 6A, 6B, 6C boundaries 5 or obstacles 10, as shown for example in FIGS. 5 and 6, change over time the maps 72 may be replaced or dynamically updated to reflect current operating conditions.

In some implementations, the system 20 detects a uniquely identifiable marker at a known geographic location and compares the known location of the marker(s) to the location detected by the GPS 32 mounted on the vehicle 22 for correcting errors in the GPS 32 measurements. Uniquely identifiable markers may include various permanent objects 10 including roadways 7, buildings 3, or fences 4. Alternatively or additionally, a uniquely identifiable marker may be a GNSS beacon or other temporary or semi-permanent object 10 with a known location. In these and other implementations, the error between the known location of the uniquely identifiable marker and the location detected by the system 20, such as by a sensor 30 and/or GPS 32, may be used to improve the accuracy of the GPS 32 location estimates, as would be appreciated in light of this disclosure. That is, the map 72 can be dynamically adjusted to offset errors that are corrected by determining the difference between detected object 10 locations and the ground truth of the object 10 location. In alternative implementations, the GPS 32 and object detection sensors 30 may be used together to establish the true location of objects 10 and/or boundaries 5 that are also readily and uniquely identifiable on aerial or satellite images. In further implementations, geo-referenced aerial imagery may also be used to correct errors in GPS 32 measurements, as would be appreciated.

In a further implementation, the system 20 may correct errors in GNSS position and locations detected by object detection sensors 30 by recording the GPS position accuracy estimated from satellite coverage and the type of correction signals available when an object 10 is detected. In further implementations, the accuracy of the object detection sensors 30 can could be recorded when the object 10 is detected. In these and other implementations, the system 20 is configured to accept the GPS position accuracy data and/or the object detection sensor 30 accuracy data to estimate the uncertainty of the exact location of the detected object 10 on the map 72. If same object 10 is detected in the future or via other measurements, the new measurements may be used to decrease the uncertainty of the position of the object 10.

In certain further implementations, vehicles 22 using the database 58 and/or map 72 of objects 10 to avoid collisions may use the uncertainty of the position of the vehicle 22 along with the uncertainty of the object 10 location in the database 58 and/or map 72 in creating guidance paths and/or emitting collision alarms. That is, as the vehicle 22 approaches an object 10 where there is an increasing probability of collision, the probability of collision can be statistically estimated using the uncertainty associated with each position—the vehicle 22 position and the object 10 position. In these and other implementations, a threshold probability of collision, for example above 5%, could be used to determine when to alert the operator or take evasive action to avoid collision or when to generate a guidance path to avoid a collision.

In some implementations, the system 20 may create integrated maps 72, using aerial or satellite images, as would be appreciated. Integrated maps 72 may also be used to identify useful features that are not readily detectible by the collision detection sensors 30, such as grass waterways 8 or field boundaries 5 that may be used in boundary 5 marking. An exemplary aerial image is shown in FIG. 5. Using this information, georeferencing of the aerial maps may be conducted by the system 20, such as by using one or more uniquely identifiable markers as discussed above. Further, these integrated maps 72 may also be used as the basis of the primary obstacle map 72 or used to correct an existing map 72.

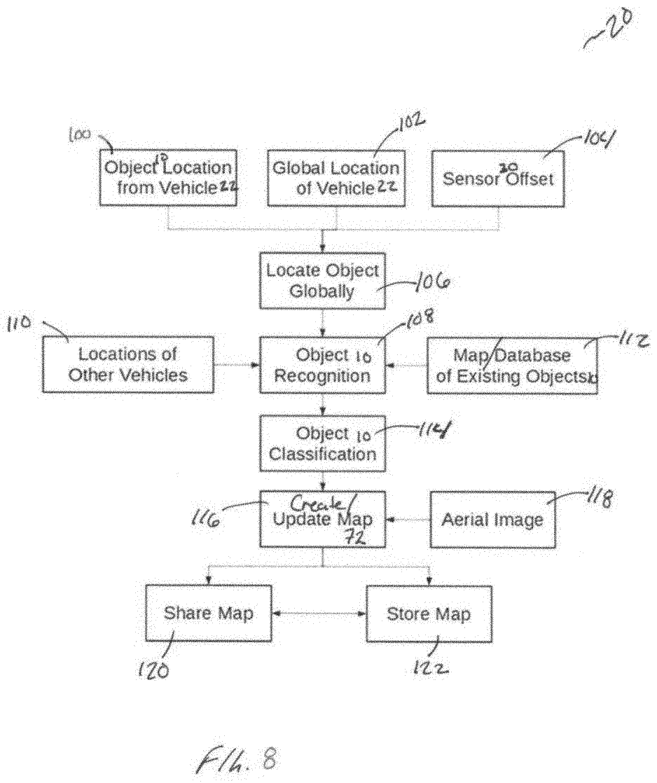

FIG. 8 depicts an exemplary implementation of the system 20 including many of the steps and sub-steps discussed herein. As would be understood, each of the steps and sub-steps is optional and may be performed in any order or not at all.

In a first step the system 20 utilizes an object collision sensor 30 to detect the presence of an object 10 (box 100). In a further optional step, the system 20 utilizes a GPS 32 unit to detect the location of the vehicle 22 at the time the object 10 was detected. In various implementations, the system 20 then utilizes a known offset (box 104) to further identify, more precisely, the location of an obstacle 10. In some implementations, the offset (box 104) is the distance between the sensor 20 and the GPS 32 receiver, as would be understood. In a further optional step, the system 20 uses the information from the sensor 30 about the object 10 distance and direction for the vehicle 22 (box 100) along with the GPS 32 location of the vehicle 22 (box 102) and the sensor offset (box 104) to determine the location of the object 10 (box 106).

In a further optional step, the system 20 uses image recognition protocols, methods, and systems to identify and recognize obstacles 10 (box 108). In various implementations, the system 20 further uses the known locations for various alternate vehicles (box 110) and existing maps 72 and databases 58 (box 112) to assist in object 10 recognition (box 108). That is, the system 20 takes all of these and other inputs (boxes 106, 110, 112) to perform object recognition (box 108) to correctly identify and place objects 10 in space.

In a still further optional step, the system 20 classifies the detected objects 10 (box 114). As discussed herein, various objects 10 may be classified as permanent, transitory, or any other category of use to operators. In various implementations, the object 10 classification step (box 114) is automatic. In various alternative implementations, the step of object 10 classification (box 114) is manual and/or operators may manually correct or adjust the automatic classifications.

The system 20 may then create or update a map 72 utilizing various inputs, as discussed above. The map 72 may further integrate an aerial image (box 118) or other imagery to supplement the map 72 created via the object collision sensors 30 and GPS 32. The map 72 may then be shared with other vehicles (box 120). In some implementations, the map 72 is stored (box 122) for future use or reference, as would be understood.

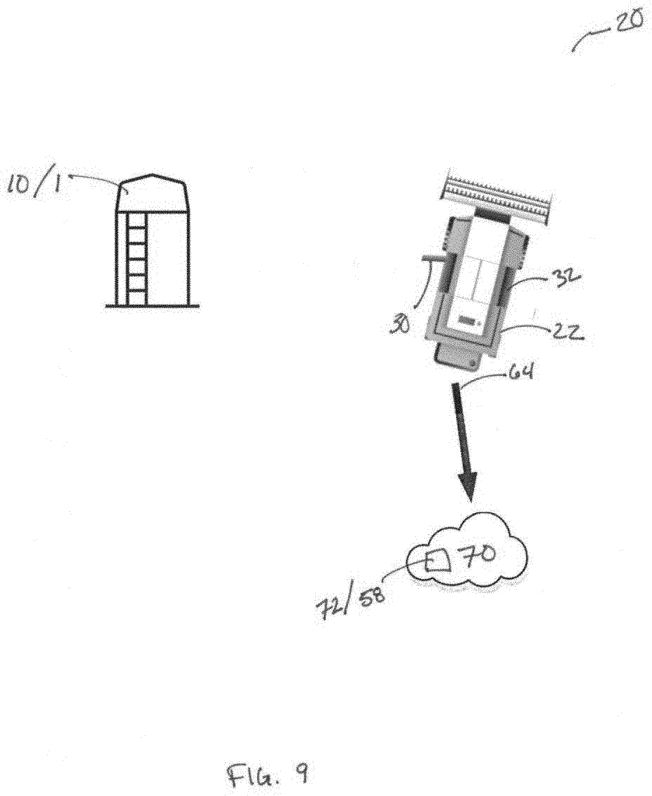

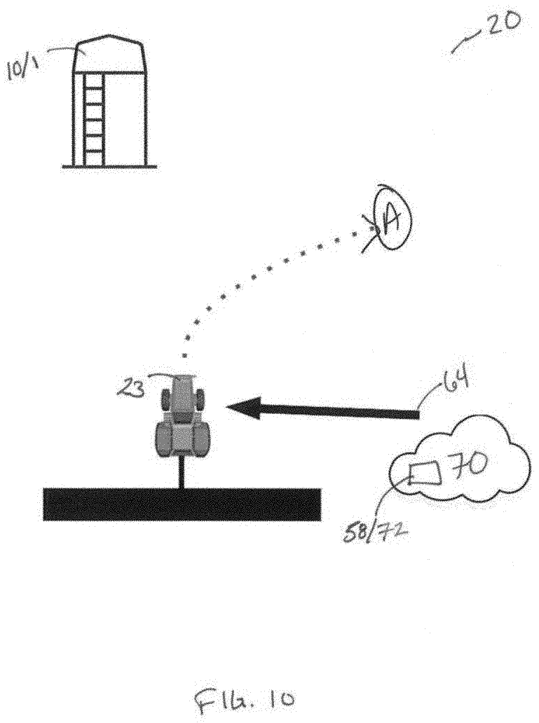

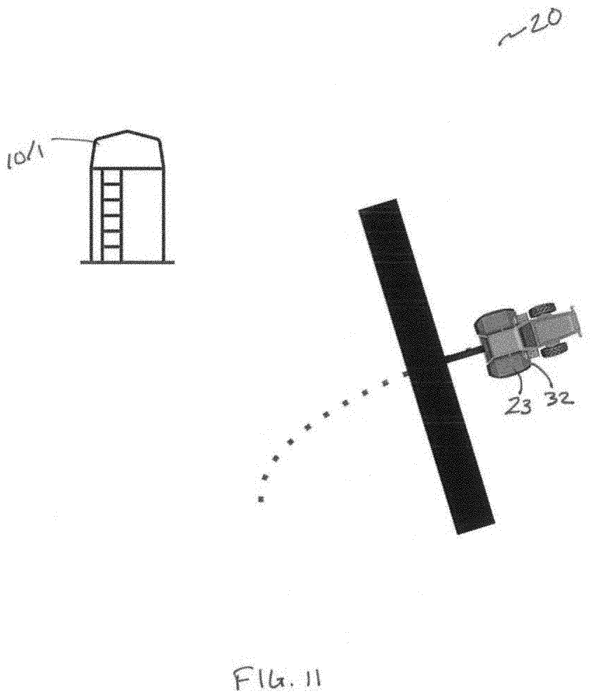

Turning now to FIGS. 9-11, in one specific example of the system 20, a vehicle 22 outfitted with a sensor 30 and GPS 32 may detect a grain silo 1 as the vehicle 22 passes near the silo 1. As the silo 1 is detected the system 20 processes information related to the obstacle 10. For example, the system 20 may locate the silo 1 on a map 72 such as by assigning GPS coordinates to the silo 1. Further, the system 20 may automatically or via an operator classify the silo 1 as a permanent object 10 to be included in the map 72 or database 58. Finally, the system 20 may update the map 72 with the location of the silo 1. In various implementations, the map 72 is stored in the cloud 70 or other remote database 58 in communication with the vehicle 22 via a communications component 64, such as but not limited to a cellular link, wi-fi, mobile data, radio link, or other wireless communication service as would be appreciated. In some implementations, the map 72 and/or database 58 may be stored on physical media that is transferred between vehicles 22, 23, such a via a portable display 52.

Continuing with the above example, a second vehicle 23 having a GPS 32 but no object detection sensors 30 may receive the location for the silo 1 from the map 72 or database 58. For example, in implementations where the map 72 is stored in the cloud 70 or remote database 58, the second vehicle 23 may be in wireless communication with the cloud 70 or remote database 58 such that the second vehicle 23 can receive information from the database 58 on a periodic or ongoing basis. In some implementations, the vehicle 23 may be in communication with the map 72 via a communications component 64, such as a cellular link or other known electronic communication link.

The system 20 may then direct the vehicle 23 to follow a guidance path (shown at A) to avoid a collision with the silo 1. In some implementations, the system 20 guides the vehicle 23 along the path A via automated steering guidance or manual control. In alternative implementations, the system 20 emits a collision warning to alert an operator to change course in order to avoid collision with an obstacle 10. In various implementations, the collision warning may be in the form of a visual and/or auditory alarm.

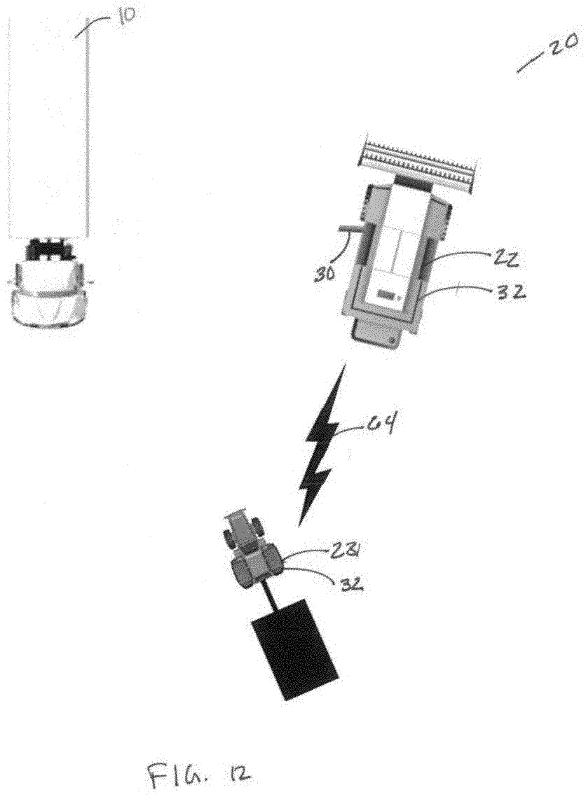

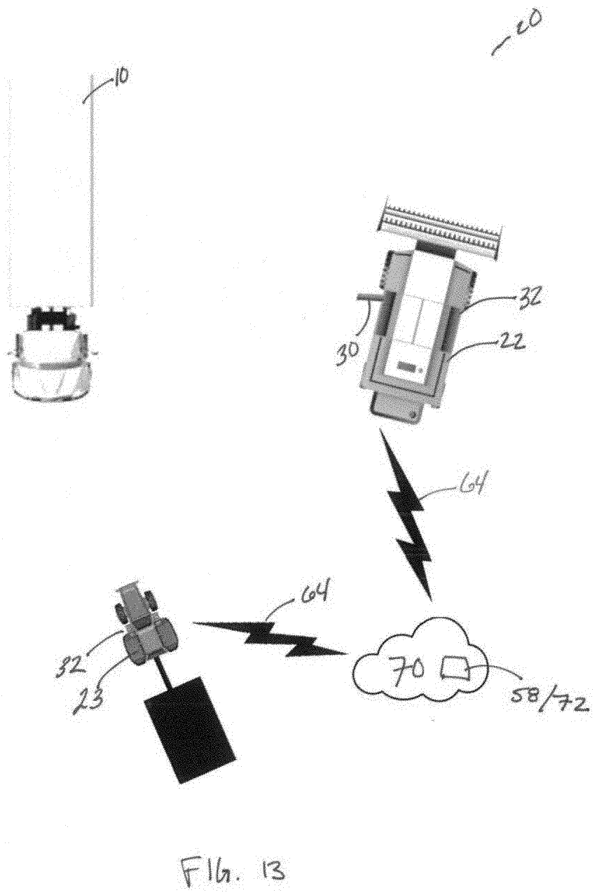

Another exemplary implementation of the system 20, in use, is shown in FIGS. 12-15. In various implementations, an object 10, such as a semi-trailer, used for hauling grain is detected by an object detection sensor 30 mounted on a first vehicle 22, such as a combine harvester 22 equipped with GPS 32. The system 20, using the certain of the herein described steps and substep, detects the position and orientation of the semi-trailer 10 via the sensor 30 and communicates that information either directly (shown for example in FIG. 12) or via a cloud 70 based database 58 or map 70 (shown for example in FIG. 13), to a second vehicle 23 with a GPS 32 such as a tractor 23 towing an implement, such as a grain cart. In various implementations, the first vehicle 22 and second vehicle 12 may be in wireless communication via one or more communications components 64 such as a radio link or other wireless communication technology as would be appreciated.

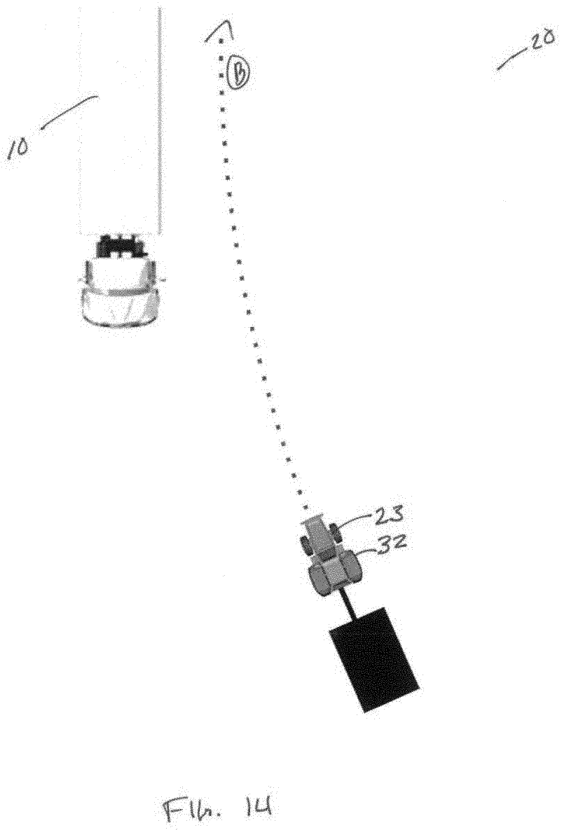

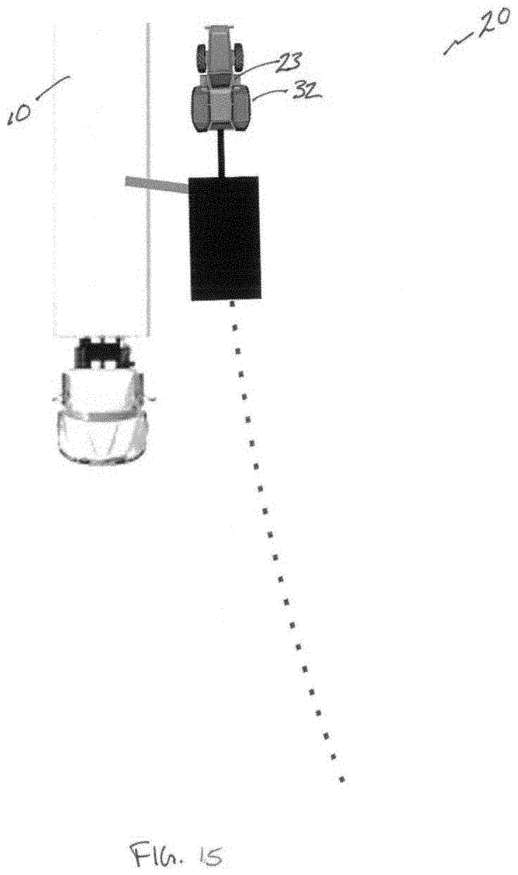

Continuing with the above exemplary implementation, the system 20 and second vehicle 23 may then use the location information about the semi-trailer 10 to plot a guidance line, such as that shown at B in FIGS. 14 and 15, to align the grain cart 23 in a precise orientation with the semi-trailer 10 for unloading. Additionally, various implementations of the system 20 may be used in conjunction with the devices and teachings of U.S. application Ser. No. 17/369,876, filed Jul. 7, 2021, which is hereby incorporated by reference.

Although the disclosure has been described with references to various embodiments, persons skilled in the art will recognized that changes may be made in form and detail without departing from the spirit and scope of this disclosure.

What is claimed is:

1. A collision avoidance system comprising:
(a) at least one sensor disposed on a vehicle;
(b) a GPS disposed on the vehicle, the GPS in communication with the sensor; and
(c) a storage medium in communication with the GPS and the sensor,
wherein the at least one sensor is constructed and arranged to detect and locate objects.

2. The collision avoidance system of claim 1, wherein the storage medium is a map or a database.

3. The collision avoidance system of claim 1, further comprising an inertial measurement unit in communication with the GPS.

4. The collision avoidance system of claim 1, further comprising an operations system configured to generate guidance paths for avoiding collisions with detected objects.

5. The collision avoidance system of claim 4, wherein the operations system is configured to determine an uncertainty of an object location and a collision probability, and wherein the operations system is configured to emit an alarm when the collision probability exceeds a threshold probability.

6. The collision avoidance system of claim 1, wherein the GPS is at a known offset from the at least one sensor, and wherein the collision avoidance system utilizes a GPS position, the known offset, and data of detected objects to localize and map objects.

7. The collision avoidance system of claim 1, wherein detected objects are classified as permanent or non-permanent.

8. A navigation system comprising:
(a) one or more collision avoidance sensors disposed on a first vehicle configured to detect objects and object data; and
(b) an operations system in communication with the one or more collision avoidance sensors comprising:
(i) a central processing unit configured to receive object data from the one or more collision avoidance sensors;
(ii) a storage medium in communication with the central processing unit for storage of the object data; and
(iii) a communications link in communication with the storage medium, the communications link configured for transmitting object data to one or more second vehicles,
wherein the navigation system is configured to generate guidance for the one or more second vehicles to avoid collisions with objects.

9. The navigation system of claim 8, wherein the storage medium comprises one or more of a map and a database.

10. The navigation system of claim 8, wherein the object data includes one or more of an object image, object GNSS coordinates, object size, object distance from the one or more collision avoidance sensors, and object identification/classification.

11. The navigation system of claim 8, further comprising a graphical user interface (GUI) in communication with the operations system configured to display object data to a user.

12. The navigation system of claim 8, wherein the operations system is configured to classify objects as permanent or non-permanent.

13. The navigation system of claim 8, further comprising a convolutional neural network for object classification.

14. The navigation system of claim 8, wherein the central processing unit is further configured to receive aerial imagery for integration with the object data.

15. A system for navigation and collision avoidance comprising:
(a) a processor in communication with at least one collision avoidance sensor on a first vehicle;
(b) a memory in communication with the processor configured to store data from the at least one collision avoidance sensor; and
(c) a navigation system in communication with the memory and a second vehicle configured to generate path guidance for avoidance of collisions with objects detected by the at least one collision avoidance sensor.

16. The system of claim 15, wherein the system is configured for
locating objects globally via data provided by the at least one collision avoidance sensor;
recognizing objects;
classifying objects; and
creating and updating maps of objects.

17. The system of claim 16, wherein the system is further configured for integrating object locations with aerial imagery.

18. The system of claim 16, wherein objects are classified as permanent or non-permanent, and wherein non-permanent objects are not included in maps of objects.

19. The system of claim 16, wherein maps of objects are dynamically updated.

20. The system of claim 15, wherein the second vehicle does not have collision avoidance sensors.
